(19) United States
(12) Patent Application Publication
(10) Pub. No.: US 2012/0106578 A1
(43) Pub. Date: May 3, 2012

(54) WAVELENGTH-TUNABLE EXTERNAL CAVITY LASER GENERATING DEVICE

(75) Inventors: Hyun Soo KIM, Daejeon (KR); Jong Sool Jeong, Daejeon (KR); Ki-Hong Yoon, Daejeon (KR); Kisoo Kim, Daejeon (KR); O-Kyun Kwon, Daejeon (KR)

(73) Assignee: ELECTRONICS AND TELECOMMUNICATIONS RESEARCH INSTITUTE, Daejeon (KR)

(21) Appl. No.: 13/241,529

(22) Filed: Sep. 23, 2011

(30) Foreign Application Priority Data
Nov. 3, 2010 (KR) 10-2010-0108684

(51) Int. Cl. H01S 3/10

(52) U.S. Cl. 372/20

(57) ABSTRACT

A wavelength-tunable external cavity laser generating device is provided. The wavelength-tunable external cavity laser generating device includes a reflection-type multi-mode interferometer, an optical amplifier disposed between the reflection-type multi-mode interferometer and an external wavelength-tunable reflector to amplify light, and an optical signal processor configured to process light from the reflection-type multi-mode interferometer. The reflection-type multi-mode interferometer includes a multi-mode waveguide, an input waveguide connecting the optical amplifier and one end of the multi-mode waveguide, and an output waveguide configured to connect the optical signal processor and the other end of the multi-mode waveguide.

### CROSS-REFERENCE TO RELATED APPLICATIONS

This U.S. non-provisional patent application claims priority under 35 U.S.C. §119 of Korean Patent Application No. 10-2010-0108684, filed on Nov. 3, 2010, in the Korean Intellectual Property Office (KIPO), the entire contents of which are hereby incorporated by reference.

### BACKGROUND OF THE INVENTION

The present invention disclosed herein relates to a laser generating device, and more particularly, to a wavelength-tunable external cavity laser generating device.

An optical communication system is being researched as one of the large-capacity communication systems. In the optical communication system, a transmitter converts an original signal into an optical signal and transmits the optical signal through a medium such as an optical cable, and a receiver receives the optical signal and converts the received optical signal into the original signal. Wavelength Division Multiplexing Passive Optical Network (WDM-PON) is a typical example of optical communication technology. The WDM-PON requires a wavelength-tunable laser.

### SUMMARY OF THE INVENTION

The present invention provides a wavelength-tunable external cavity laser generating device capable of high-speed modulation.

The present invention also provides a wavelength-tunable external cavity laser generating device with increased integration density.

In some embodiments of the present invention, a wavelength-tunable external cavity laser generating device includes: a reflection-type multi-mode interferometer; an optical amplifier disposed between the reflection-type multi-mode interferometer and an external wavelength-tunable reflector to amplify light; and an optical signal processor configured to process light from the reflection-type multi-mode interferometer, wherein the optical amplifier, the reflection-type multi-mode interferometer, and the optical signal processor are connected on a substrate to form a continuous waveguide, and the reflection-type multi-mode interferometer includes: a multi-mode waveguide; an input waveguide connecting the optical amplifier and one end of the multi-mode waveguide; and an output waveguide configured to connect the optical signal processor and the other end of the multi-mode waveguide.

In some embodiments, the output waveguide is formed at the other end of the multi-mode waveguide on a second axis spaced apart from a first axis along which light is inputted from the input waveguide.

In other embodiments, the reflection-type multi-mode interferometer further includes a reflection part provided at the other end of the multi-mode waveguide on a third axis spaced apart from the output waveguide and the first axis.

In further embodiments, the reflection part includes a high-reflectivity material formed at the other end of the multi-mode waveguide.

In still further embodiments, the reflection part and the output waveguide are symmetrical with respect to the first axis.

In still further embodiments, the reflection-type multi-mode interferometer further includes: a multi-mode interferometer including an input port connected to the other end of the multi-mode waveguide; and a feedback waveguide configured to connect the output ports of the multi-mode interferometer.

In still further embodiments, the input port is connected to the other end of the multi-mode waveguide on a third axis spaced apart from the output waveguide and the first axis.

In still further embodiments, the multi-mode waveguide includes: a third multi-mode waveguide extending a second axis that is not parallel to a first axis along which the light is inputted from the input waveguide; a fourth multi-mode waveguide extending a third axis that is not parallel to the first axis and the second axis; and a connection waveguide configured to connect the third multi-mode waveguide and the fourth multi-mode waveguide.

In still further embodiments, the ratio of the output light transmitted through the output waveguide to the light reflected by the end of the fourth multi-mode waveguide varies according to the angle between the second axis and the third axis.

In still further embodiments, the wavelength-tunable external cavity laser generating device further includes a phase shifter provided at least one of both ends of the optical amplifier.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a wavelength-tunable external cavity laser generating device according to a first exemplary embodiment of the present invention;

FIG. 2 is a diagram illustrating a multi-mode interferometer;

FIG. 3 is a diagram illustrating a reflection-type multi-mode interferometer according to a first embodiment of the present invention;

FIG. 4 is a diagram illustrating a reflection-type multi-mode interferometer according to a second embodiment of the present invention;

FIG. 5 is a diagram illustrating a reflection-type multi-mode interferometer according to a third embodiment of the present invention;

FIG. 6 is a diagram illustrating a reflection-type multi-mode interferometer according to a fourth embodiment of the present invention; and

FIG. 7 is a diagram illustrating a wavelength-tunable external cavity laser generating device according to a second exemplary embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

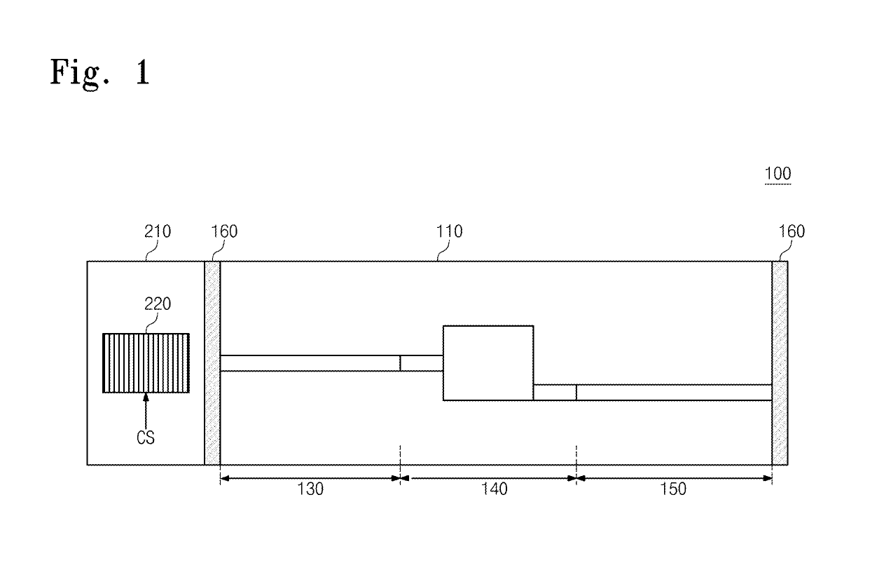

FIG. 1 is a diagram illustrating a wavelength-tunable external cavity laser generating device 100 according to a first exemplary embodiment of the present invention.

Referring to FIG. 1, the wavelength-tunable external cavity laser generating device 100 includes a first substrate 110 and a second substrate 210. For example, the first substrate 110 and the second substrate 210 may be formed of different materials.

An optical amplifier 130, a reflection-type multi-mode interferometer 140, and an optical signal processor 150 are disposed on the first substrate 110. The optical amplifier 130, the reflection-type multi-mode interferometer 140, and the optical signal processor 150 constitute a continuous waveguide.

An external wavelength-tunable reflector 220 is disposed on the second substrate 210. The external wavelength-tunable reflector 220 has a tunable reflection band.

The external wavelength-tunable reflector 220 is configured to reflect light of a predetermined wavelength among the input light. The reflection-type multi-mode interferometer 140 is configured to reflect a portion of the input light and transmit the other portion.

The optical amplifier 130 is disposed between the external wavelength-tunable reflector 220 and the reflection-type multi-mode interferometer 140. A resonance is generated between the external wavelength-tunable reflector 220 and the reflection-type multi-mode interferometer 140. The optical amplifier 130 compensates for a light attenuation caused by the resonance. Thus, a laser is generated by the external wavelength-tunable reflector 220, the optical amplifier 130 and the reflection-type multi-mode interferometer 140.

The laser generated by the external wavelength-tunable reflector 220, the optical amplifier 130 and the reflection-type multi-mode interferometer 140 is provided to the optical signal processor 150. For example, the optical signal processor 150 may include an optical modulator. The laser generated by the external wavelength-tunable reflector 220, the optical amplifier 130 and the reflection-type multi-mode interferometer 140 is processed by the optical signal processor 150.

For example, an optical cable may be provided at an output terminal of the optical signal processor 150, and an output laser of the optical signal processor 150 may be transmitted through the optical cable.

For example, the optical amplifier 130 may include a ridge-type gain waveguide or a planner buried heterostructure (PBH) gain waveguide. The optical amplifier 130 may include an InGaAsP/InGaAsP multiple quantum well or an InGaAsP bulk having 1.55 micrometers or similar band gap.

For example, the reflection-type multi-mode interferometer 140 may have a similar structure to a multi-mode interferometer. For example, the reflection-type multi-mode interferometer 140 may have the same structure as a multi-mode interferometer ridded of at least one output port. That is, among the light inputted to the reflection-type multi-mode interferometer 140, the light corresponding to at least one removed output port may be reflected, and the light corresponding to at least one unremoved output port may be transmitted.

The optical signal processor 150 may include a ridge-type waveguide, a deep ridge-type waveguide, or a planner buried heterostructure (PBH) waveguide. The optical signal processor 150 may include a Mach-Zehender interference modulator, an electric field absorption modulator, or a phase modulator. For example, the optical signal processor 150 may include an electric field absorption modulator including an InGaAsP/InGaAsP multiple quantum well or an InGaAsP bulk having a band gap of a shorter wavelength of 40 to 70 nanometers than the band gap of the optical amplifier 130. As another example, the optical signal processor 150 may include a Mach-Zehender interference modulator including an InGaAsP/InGaAsP multiple quantum well or an InGaAsP bulk having a band gap of 1.2 to 1.4 micrometers.

The external wavelength-tunable reflector 220 may include a film-type reflector, a Bragg grating reflector, a waveguide-type reflector, or a diffraction grating (e.g., a polymer grating) having a tunable reflection band. For example, the reflection band of the external wavelength-tunable reflector 220 may vary according to a control signal CS. For example, the reflection band of the external wavelength-tunable reflector 220 may vary according to an electrooptic effect or a thermooptic effect by a control signal CS. The control signal CS may be a voltage or a current.

For example, an anti-reflection coating 160 may be provided at least one of both ends of the optical amplifier 130, the reflection-type multi-mode interferometer 140 and the optical signal processor 150 constituting the continuous waveguide. When the anti-reflection coating 160 is provided between the external wavelength-tunable reflector 220 and the optical amplifier 130, a reflection loss can be reduced in a resonance mode generated between the external wavelength-tunable reflector 220 and the optical amplifier 130 and the reflection-type multi-mode interferometer 140. When the anti-reflection coating 160 is provided at an output terminal of the optical signal processor 150, a reflection loss can be reduced at an output terminal of the wavelength-tunable external cavity laser generating device 100.

For example, when the anti-reflection coating 160 is provided at both ends of the optical amplifier 130, the reflection-type multi-mode interferometer 140 and the optical signal processor 150 constituting the continuous waveguide, a Febry-Perot resonance, which may be generated at the optical amplifier 130, the reflection-type multi-mode interferometer 140 and the optical signal processor 150 constituting the continuous waveguide, can be suppressed.

For example, an optical spot size converter (SSC) (not illustrated) may be additionally provided between the external wavelength-tunable reflector 220 and the optical amplifier 130. When the optical spot size converter is additionally provided between the external wavelength-tunable reflector 220 and the optical amplifier 130, the coupling efficiency of the external wavelength-tunable reflector 220 and the optical amplifier 130 can be improved.

Likewise, an optical spot size converter (SSC) (not illustrated) may be additionally provided at an output terminal of the optical signal processor 150. When the optical spot size converter is additionally provided at the output terminal of the optical signal processor 150, the coupling efficiency of the optical signal processor 150 and a transmission medium (e.g., an optical fiber) connected to the output terminal of the optical signal processor 150 can be improved.

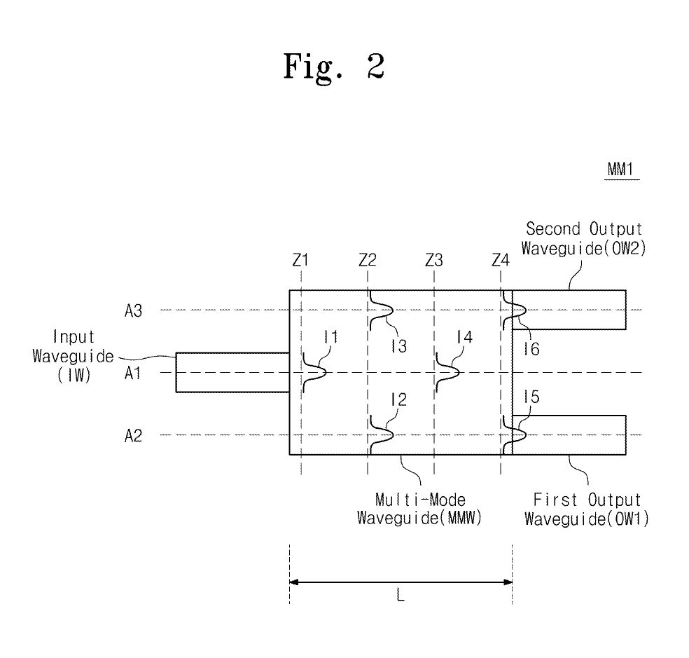

FIG. 2 is a diagram illustrating a multi-mode interferometer (MMI).

Referring to FIG. 2, the multi-mode interferometer (MMI) includes an input waveguide IW, a multi-mode waveguide MMW, a first output waveguide OW1, and a second output waveguide OW2.

The multi-mode interferometer (MMI) is a device based on a self-imaging principle. Light is inputted from the input waveguide IW to one end of the multi-mode waveguide MMW. The input waveguide IW may be a single-mode waveguide. The light inputted into the multi-mode waveguide MMW is divided into a plurality of modes. By the interference between the modes, images are formed in the multi-mode waveguide MMW. Specifically, a single image or multiple images are periodically formed in the multi-mode waveguide MMW along the waveguide direction of the light inputted into the multi-mode waveguide MMW.

For example, it is illustrated that a single image I1 is formed at a first point Z1 adjacent to the input waveguide IW, on a first axis A1 along which the input waveguide IW is provided. It is illustrated that multiple images 12 and 13 are formed at a second point Z2 spaced apart from the first point Z1 in the waveguide direction, on second and third axes A2 and A3 along which the first and second output waveguides OW1 and OW2. It is illustrated that a single image 14 is formed at a third point Z3 spaced apart from the second point Z2 in the waveguide direction, on the first axis A1. It is illustrated that multiple images 15 and 16 are formed at a fourth point Z4 spaced apart from the third point Z3 in the waveguide direction, on the second and third axes A2 and A3.

The operational characteristics of the multi-mode interferometer (MMI) may vary according to the length L of the multi-mode waveguide MMW and the locations of the output waveguides OW1 and OW2. For example, in FIG. 2, the length L of the multi-mode waveguide MMW is set such that multiple images I5 and I6 are formed at the other end of the multi-mode waveguide MMW. Also, it is illustrated that the output waveguides OW1 and OW2 are provided at the forming region of the multiple images I5 and I6 among the regions of the other end of the multi-mode waveguide MMW. Herein, the energy corresponding to the fifth image I5 is transmitted through the first output waveguide OW1, and the energy corresponding to the sixth image 16 is transmitted through the second output waveguide OW2. That is, the multi-mode interferometer MMI of FIG. 2 can operate as an optical splitter.

It is illustrated that a single image or two or more multiple images are formed in the multi-mode waveguide MMW of FIG. 2. However, the number of multiple images formed in the multi-mode waveguide MMW may vary according to the width of the multi-mode waveguide MMW. When the number of multiple images formed in the multi-mode waveguide MMW varies, the present invention is not limited to the case where two multiple images are formed at the other end of the multi-mode waveguide MMW. That is, the present invention is not limited to the case where two output waveguides are provided at the other end of the multi-mode waveguide MMW.

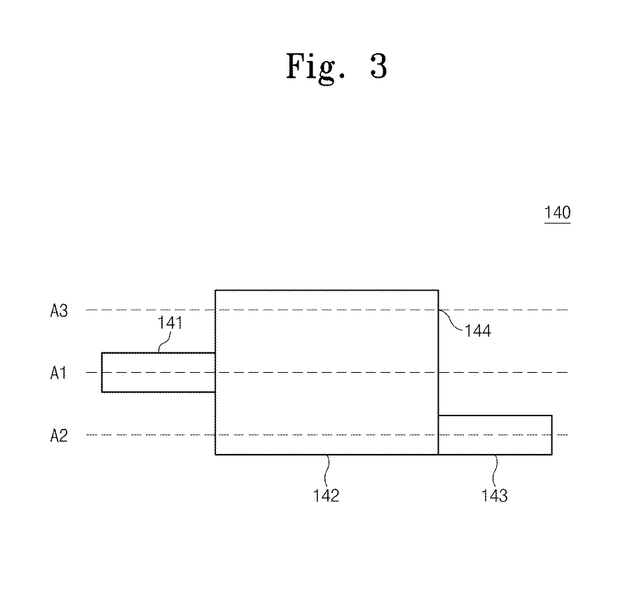

FIG. 3 is a diagram illustrating a reflection-type multi-mode interferometer 140 according to a first embodiment of the present invention.

Referring to FIG. 3, the reflection-type multi-mode interferometer 140 includes an input waveguide 141, a multi-mode waveguide 142, and an output waveguide 143.

For example, the input waveguide 141 and the output waveguide 143 are single-mode waveguides. The input waveguide 141 is provided along a first axis A1. The output waveguide 143 is provided along a second axis A2 that is parallel to the first axis A1 and is spaced apart from the first axis A1 by a predetermined distance. The input waveguide 141 is connected to one end of the multi-mode waveguide 142, and the output waveguide 143 is connected to the other end of the multi-mode waveguide 142. The input waveguide 141 and the output waveguide 143 may have a smaller width than the multi-mode waveguide 142.

The reflection-type multi-mode interferometer 140 has a similar structure to the multi-mode interferometer described with reference to FIG. 2. For example, the reflection-type multi-mode interferometer 140 may have the same structure as a multi-mode interferometer ridded of at least one output port.

Like the multi-mode interferometer, the reflection-type multi-mode interferometer 140 is configured to split input light. Herein, the reflection-type multi-mode interferometer 140 is configured to transmit a portion of the distributed light to the output waveguide 143 and reflect the other portion of the distributed light to the input waveguide 141.

For example, the light inputted through the input waveguide 141 to one end of the multi-mode waveguide 142 forms multiple images at the other end of the multi-mode waveguide 142. The image corresponding to the output waveguide 143, among the multiple images, is transmitted through the output waveguide 143. The output waveguide 143 transmits a portion of the light, inputted through the input waveguide 141, to the optical signal processor 150. The image not corresponding to the output waveguide 143, among the multiple images, is reflected by the multi-mode waveguide 142 and is transmitted through the input waveguide 141 to the optical amplifier 130. For example, a portion of the input light may be reflected by the region corresponding to the removed output port, among the regions of the multi-mode waveguide 142.

For example, as described with reference to FIG. 2, it is assumed that two multiple images I5 and I6 are formed at the other end of the multi-mode waveguide 142. For example, it is assumed that the multiple images I5 and I6 are formed on the second and third axes A2 and A3. The output waveguide 143 is provided on the second axis A2. Accordingly, among the input light, the light corresponding to the fifth image I5 is transmitted through the output waveguide 143.

The other end of the multi-mode waveguide 142 is provided on the third axis A3. Accordingly, among the input light, the light corresponding to the sixth image I6 is reflected by the other end of the multi-mode waveguide 142, specifically by the region corresponding to the third axis A3, among the regions of the other end of the multi-mode waveguide 142. That is, among the regions of the other end of the multi-mode waveguide 142, the region reflecting the input light may be defined as a reflection region 144.

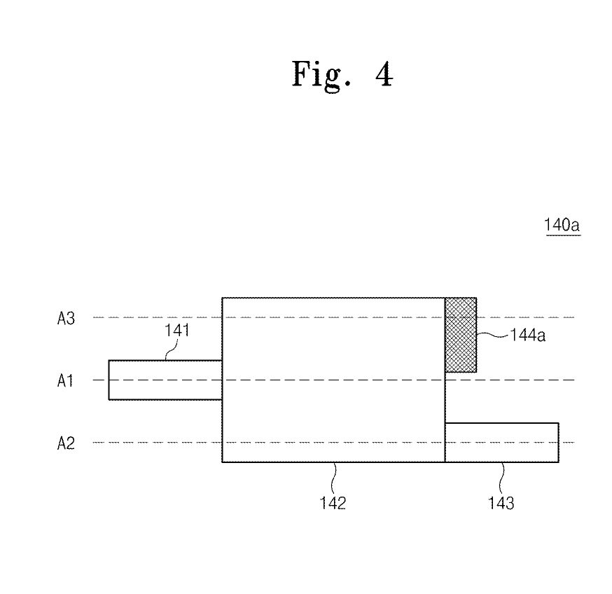

FIG. 4 is a diagram illustrating a reflection-type multi-mode interferometer 140a according to a second embodiment of the present invention.

Referring to FIG. 4, as compared to the reflection-type multi-mode interferometer 140 of FIG. 3, the reflection-type multi-mode interferometer 140a may further include a reflection part 144a that is provided at the region corresponding to the third axis A3, among the regions of the other ends of the multi-mode waveguide 142. The reflection part 144a includes a high-reflectivity material. For example, the reflection part 144a may include a high-reflectivity material such as aurum (Au) and argentum (Ag).

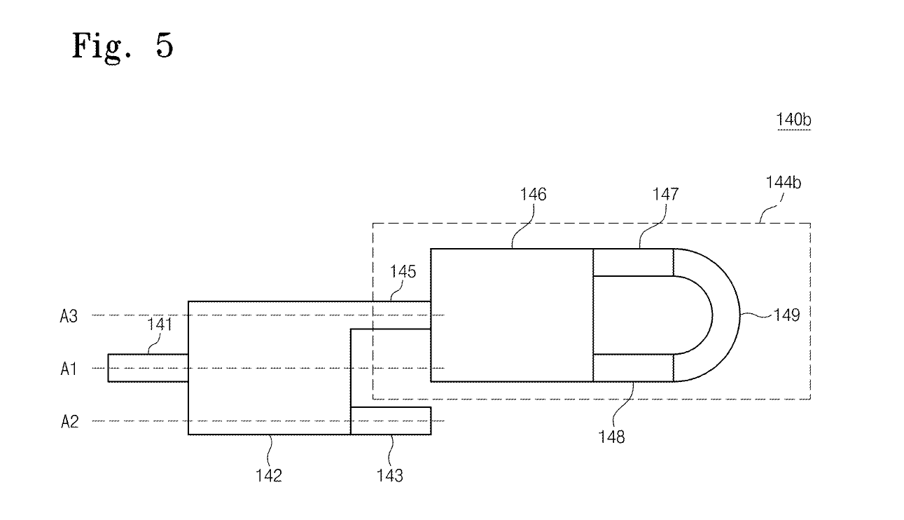

FIG. 5 is a diagram illustrating a reflection-type multi-mode interferometer 140b according to a third embodiment of the present invention.

Referring to FIG. 5, as compared to the reflection-type multi-mode interferometer 140 of FIG. 3, the reflection-type multi-mode interferometer 140b may further include a reflection part 144b that includes a first waveguide 145, a second multi-mode waveguide 146, a second waveguide 147, a third waveguide 148, and a feedback waveguide 149.

The first waveguide 145 is connected to the other end of the multi-mode waveguide 142. The second multi-mode waveguide 146 is connected to the other end of the first waveguide 145. The second and third waveguides 147 and 148 are connected to the other end of the second multi-mode waveguide 146. The feedback waveguide 149 connects the other end of the second waveguide 147 and the other end of the third waveguide 148.

For example, the first waveguide 145, the second multi-mode waveguide 146, the second waveguide 147, and the third waveguide 148 constitute a multi-mode interferometer. The first waveguide 145 is provided as an input waveguide of the multi-mode interferometer. The second and third waveguides 147 and 148 are provided as output waveguides of the multi-mode interferometer.

That is, the light corresponding to the image formed at the region corresponding to the reflection part 144b, among the images formed at the other end of the multi-mode waveguide 142, is inputted into the first waveguide 145. The light inputted into the first waveguide 145 are split and transmitted to the second and third waveguides 147 and 148.

The second and third waveguides 147 and 148 are connected to each other by the feedback waveguide 149. Accordingly, the light transmitted to the second waveguide 147 is transmitted to the multi-mode waveguide 142 through the feedback waveguide 149, the third waveguide 148, the second multi-mode waveguide 146 and the first waveguide 145. Likewise, the light transmitted to the third waveguide 148 is transmitted to the multi-mode waveguide 142 through the feedback waveguide 149, the second waveguide 147, the second multi-mode waveguide 146 and the first waveguide 145. That is, it can be understood that the light inputted into the reflection part 144b is reflected by the reflection part 144b.

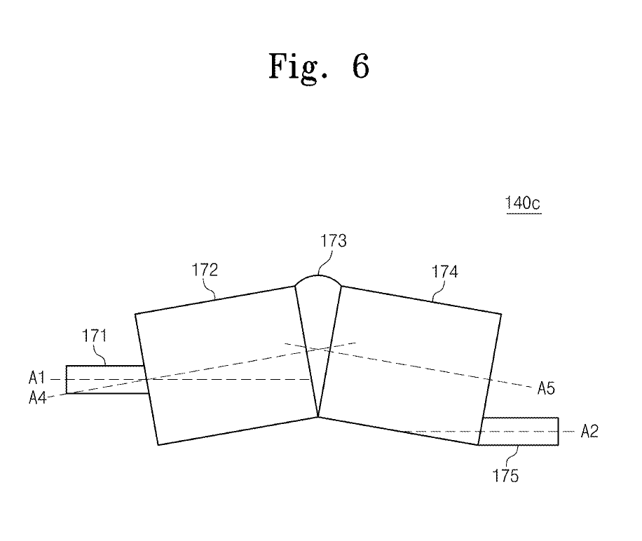

FIG. 6 is a diagram illustrating a reflection-type multi-mode interferometer 140c according to a fourth embodiment of the present invention.

Referring to FIG. 6, the reflection-type multi-mode interferometer 140c includes an input waveguide 171, a third multi-mode waveguide 172, a connection waveguide 173, a fourth multi-mode waveguide 174, and an output waveguide 175. As compared to the reflection-type multi-mode interferometer 140 of FIG. 3, it can be understood that the multi-mode waveguide 142 includes the third multi-mode waveguide 172, the connection waveguide 173, and the fourth multi-mode waveguide 174.

As described with reference to FIG. 3, the input waveguide 171 and the output waveguide 175 are provided along a first axis A1 and a second axis A2, respectively. The third multi-mode waveguide 172 is provided along a fourth axis A4 that has a predetermined slope with respect to the first axis A1. The fourth multi-mode waveguide 174 is provided along a fifth axis A5 that has predetermined slopes with respect to the first axis A1 and the fourth axis A4. The connection waveguide 173 connects the third and fourth multi-mode waveguides 172 and 174. For example, the third multi-mode waveguide 172 and the fourth multi-mode waveguide 174 may be symmetrical with respect to the connection waveguide 173.

The ratio of the output light transmitted through the output waveguide 175 to the light reflected by the reflection part 144 may vary according to the angle between the fourth axis A4 of the third multi-mode waveguide 172 and the fifth axis A5 of the fourth multi-mode waveguide 174.

As described above, the wavelength-tunable external cavity laser generating device 100 according to a first exemplary embodiment of the present invention includes an optical device integrated in a substrate and a wavelength-tunable reflector integrated in a substrate. The optical device includes an optical amplifier 130, a reflection-type multi-mode interferometer 140, and an optical signal processor 150. The optical signal processor 150 (e.g., an optical modulator), the optical amplifier 130, and the reflection-type multi-mode interferometer 140 are integrated to construct a continuous waveguide. Accordingly, it is possible to perform the high-speed modulation of the laser outputted through the reflection-type multi-mode interferometer 140.

The reflection band of the external wavelength-tunable reflector 220 varies according to the control signal CS. Accordingly, the wavelength-tunable external cavity laser generating device 100 outputs a wavelength-tunable single-mode laser.

The external wavelength-tunable reflector 220 and the optical device including the optical amplifier 130, the reflection-type multi-mode interferometer 140, and the optical signal processor 150 are formed on semiconductor substrates. Accordingly, the integration density of the wavelength-tunable external cavity laser generating device 100 can be improved.

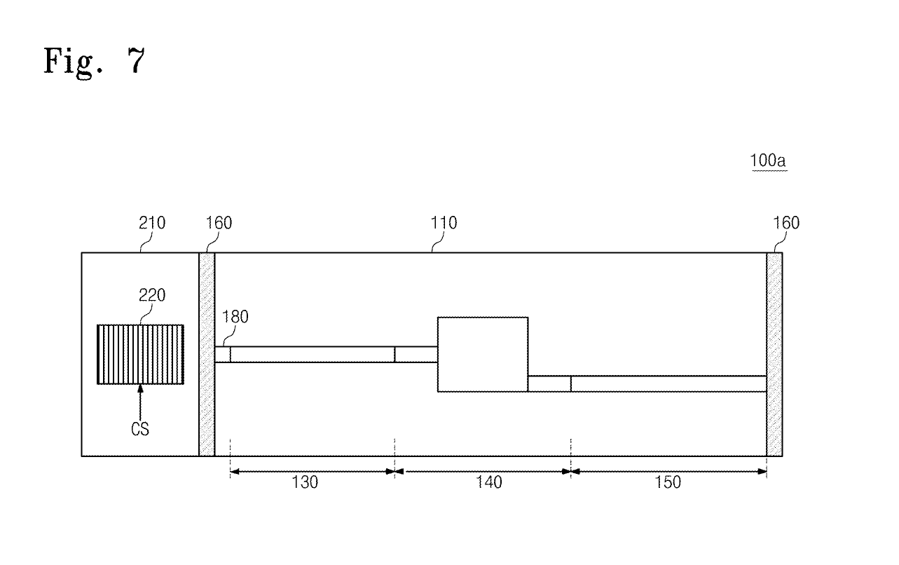

FIG. 7 is a diagram illustrating a wavelength-tunable external cavity laser generating device 100a according to a second exemplary embodiment of the present invention.

Referring to FIG. 7, as compared to the wavelength-tunable external cavity laser generating device 100 of FIG. 1, the wavelength-tunable external cavity laser generating device 100a further includes a phase shifter 180.

The phase shifter 180 may shift the phase of the light that is reflected by the reflection-type multi-mode interferometer 140 and is inputted to the external wavelength-tunable reflector 220. That is, the light intensity of the laser generated by the wavelength-tunable external cavity laser generating device 100 can be maximized by the phase shifter 180.

For example, it is illustrated that the phase shifter 180 is provided between the external wavelength-tunable reflector 220 and the optical amplifier 130. As another example, the phase shifter 180 may be provided between the external wavelength-tunable reflector 220 and the reflection-type multi-mode interferometer 140.

In the above embodiments, it has been described that the output laser of the wavelength-tunable external cavity laser generating device 100 corresponds to a predetermined wavelength or a predetermined band. Herein, the output laser of the wavelength-tunable external cavity laser generating device 100 is a laser that is not processed by the optical signal processor 150. When the laser is processed by the optical signal processor 150, the wavelength or band of the output laser of the wavelength-tunable external cavity laser generating device 100 may vary.

As described above, according to the present invention, an optical amplifier, a reflection-type multi-mode interferometer, and an optical modulator are integrated in a continuous waveguide mode on a single substrate. Thus, the present invention can provide a wavelength-tunable external cavity laser generating device capable of high-speed modulation.

Also, according to the present invention, an optical amplifier, a reflection-type multi-mode interferometer, and an optical modulator are integrated in a continuous waveguide mode on a single substrate, and an external wavelength-tunable reflector is provided on the substrate. Thus, the present invention can provide a wavelength-tunable external cavity laser generating device with increased integration density.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wavelength-tunable external cavity laser generating device comprising:
a reflection-type multi-mode interferometer;
an optical amplifier disposed between the reflection-type multi-mode interferometer and an external wavelength-tunable reflector to amplify light; and
an optical signal processor configured to process light from the reflection-type multi-mode interferometer,
wherein the optical amplifier, the reflection-type multi-mode interferometer, and the optical signal processor are connected on a substrate to form a continuous waveguide, and
the reflection-type multi-mode interferometer comprises:
a multi-mode waveguide;
an input waveguide connecting the optical amplifier and one end of the multi-mode waveguide; and
an output waveguide configured to connect the optical signal processor and the other end of the multi-mode waveguide.

2. The wavelength-tunable external cavity laser generating device of claim 1, wherein the output waveguide is formed at the other end of the multi-mode waveguide on a second axis spaced apart from a first axis along which light is inputted from the input waveguide.

3. The wavelength-tunable external cavity laser generating device of claim 2, wherein the reflection-type multi-mode interferometer further comprises a reflection part provided at the other end of the multi-mode waveguide on a third axis spaced apart from the output waveguide and the first axis.

4. The wavelength-tunable external cavity laser generating device of claim 3, wherein the reflection part comprises a high-reflectivity material formed at the other end of the multi-mode waveguide.

5. The wavelength-tunable external cavity laser generating device of claim 3, wherein the reflection part and the output waveguide are symmetrical with respect to the first axis.

6. The wavelength-tunable external cavity laser generating device of claim 2, wherein the reflection-type multi-mode interferometer further comprises:
a multi-mode interferometer comprising an input port connected to the other end of the multi-mode waveguide; and
a feedback waveguide configured to connect the output ports of the multi-mode interferometer.

7. The wavelength-tunable external cavity laser generating device of claim 6, wherein the input port is connected to the other end of the multi-mode waveguide on a third axis spaced apart from the output waveguide and the first axis.

8. The wavelength-tunable external cavity laser generating device of claim 1, wherein the multi-mode waveguide comprises:
a third multi-mode waveguide extending a second axis that is not parallel to a first axis along which the light is inputted from the input waveguide;
a fourth multi-mode waveguide extending a third axis that is not parallel to the first axis and the second axis; and
a connection waveguide configured to connect the third multi-mode waveguide and the fourth multi-mode waveguide.

9. The wavelength-tunable external cavity laser generating device of claim 8, wherein the ratio of the output light transmitted through the output waveguide to the light reflected by the end of the fourth multi-mode waveguide varies according to the angle between the second axis and the third axis.

10. The wavelength-tunable external cavity laser generating device of claim 1, further comprising a phase shifter provided at least one of both ends of the optical amplifier.
